(19) United States
(12) Patent Application Publication
(10) Pub. No.: US 2026/0352995 A1
(43) Pub. Date: Nov. 5, 2026

(54) Speaker

(71) Applicant: AAC Microtech (Changzhou) Co., Ltd., Changzhou City (CN)

(72) Inventors: Zhiwei Zhong, Changzhou (CN); Xin Jin, Changzhou (CN)

(21) Appl. No.: 19/319,707

(22) Filed: Sep. 4, 2025

Related U.S. Application Data
(63) Continuation of application No. PCT/CN2025/092532, filed on Apr. 30, 2025.

(51) Int. Cl. H04R 1/24; H04R 1/06; H04R 7/18; H04R 9/02; H04R 9/04; H04R 9/06

(52) U.S. Cl. CPC H04R 1/24; H04R 1/06; H04R 7/18; H04R 9/025; H04R 9/045; H04R 9/06; H04R 2209/041; H04R 2400/11

(57) ABSTRACT

The invention provides a speaker, which includes a frame and a vibration system and a magnetic circuit system. The vibration system includes a tweeter unit having a tweeter diaphragm and a tweeter voice coil assembly. The tweeter voice coil assembly includes a tweeter frame, a first tweeter voice coil, and a second tweeter voice coil wound around an upper portion and a lower portion of the tweeter frame respectively. The first tweeter voice coil and the second tweeter voice coil are wound in opposite directions. By disposing the first tweeter voice coil and the second tweeter voice coil on the upper and lower portions of the tweeter frame, the two voice coils can simultaneously drive the tweeter diaphragm, providing greater driving force for the vibration of the tweeter diaphragm, enhancing electromagnetic driving force, and thereby improving the high-frequency performance of the speaker.

### TECHNICAL FIELD

The invention relates to the field of electroacoustic technology, more particularly to a speaker.

### BACKGROUND

As a transducer device that converts electrical signals into sound signals, speakers are applied in electronic devices, and the performance of speaker devices directly affects the sound quality of electronic devices. In the prior art, the installation space for speakers is relatively small, and within the limited space, the magnetic circuit efficiency of the tweeter unit in the speaker device is low, and the BL value (which refers to the product of the magnetic flux density B produced by the current in the speaker voice coil and the coil length L) at high frequencies is low, resulting in high-frequency sound distortion in the speaker device.

Therefore, it is necessary to provide a speaker that can improve the high-frequency performance of speaker devices.

### SUMMARY

The object of the invention is to provide a speaker with improved high-frequency performance.

The technical solution of the invention is as follows:

A speaker, comprising a frame and a vibration system and a magnetic circuit system that are fixed to the frame respectively, wherein the magnetic circuit system drives the vibration system to produce sound; the vibration system includes a tweeter unit disposed on one side of the magnetic circuit system, the tweeter unit includes a tweeter diaphragm and a tweeter voice coil assembly disposed on a side of the tweeter diaphragm close to the magnetic circuit system; the tweeter voice coil assembly includes a tweeter frame and a first tweeter voice coil and a second tweeter voice coil wound around an upper portion and a lower portion of the tweeter frame respectively, wherein the first tweeter voice coil and the second tweeter voice coil are wound in opposite directions.

As an improvement, the tweeter frame includes a tubular body extending along a vibration direction of the vibration system and a flange disposed at an end of the tubular body away from the magnetic circuit system, the flange is connected to the tweeter diaphragm; the first tweeter voice coil is connected to the flange and the tubular body respectively, the second tweeter voice coil is disposed at an end of the tubular body away from the first tweeter voice coil.

As an improvement, a reinforcement plate is disposed between the flange and the tweeter diaphragm, the reinforcement plate is provided with an avoidance portion for avoiding leads of the tweeter voice coil assembly.

As an improvement, the tweeter frame is a polyimide tweeter frame or an aluminum alloy tweeter frame.

As an improvement, the first tweeter voice coil and the second tweeter voice coil are directly series-wound on the tweeter frame.

As an improvement, the first tweeter voice coil and the second tweeter voice coil are wound separately and then bonded or welded to the tweeter frame.

As an improvement, the magnetic circuit system includes a first magnetic yoke, a center magnet and a first side magnet received on the first magnetic yoke, and a second side magnet disposed on a side of the center magnet close to the vibration system, the first side magnet is spaced apart from an outer periphery of the center magnet, the first side magnet and the second side magnet are both magnetized in opposite directions with respect to the center magnet; the frame includes a first frame, the tweeter diaphragm is supported on the first frame, the first frame is disposed on the second side magnet.

As an improvement, a hole structure is formed in a central region of the second side magnet, a tweeter inner pole piece is disposed in the hole structure and spaced apart from an inner wall of the hole structure, the tweeter inner pole piece is disposed on the center magnet, a first magnetic gap is formed between the tweeter inner pole piece and the inner wall of the second side magnet, the tweeter voice coil assembly is inserted into the first magnetic gap.

As an improvement, the tweeter inner pole piece is a tweeter inner pole plate or a tweeter inner magnet.

As an improvement, the tweeter unit further includes a flexible printed circuit (FPC), the FPC is formed as an open ring as a whole, the FPC includes a first portion and a second portion connected between the first portion, the first portion passes through the tweeter inner pole piece and the center magnet respectively, the second portion is connected to a top surface of the tweeter inner pole piece and a bottom surface of the center magnet respectively; a first through hole and a second through hole for the first portion to pass through are formed in the tweeter inner pole piece and the center magnet respectively, an opening of the FPC is disposed on the second portion connected to the top surface of the tweeter inner pole piece.

As an improvement, the vibration system further includes a woofer unit coaxially disposed with the tweeter unit, the woofer unit is disposed surrounding an outer periphery of the tweeter unit; the frame includes a second frame, the woofer unit includes a woofer diaphragm fixed to the second frame and a woofer voice coil driving the woofer diaphragm.

As an improvement, a second magnetic gap is formed between the first side magnet and the center magnet, the woofer voice coil is inserted into the second magnetic gap.

The speaker of the invention includes a tweeter unit provided with the tweeter voice coil assembly, wherein the tweeter voice coil assembly adopts the first tweeter voice coil and the second tweeter voice coil disposed on the upper and lower portions of the tweeter frame, through optimized design of the magnetic circuit, the two voice coils can simultaneously drive the tweeter diaphragm, providing greater driving force for the vibration of the tweeter diaphragm, enhancing electromagnetic driving force, and thereby improving the high-frequency performance of the speaker; making full use of limited space while ensuring miniaturization of the speaker while maintaining high performance.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of the speaker of the invention.

FIG. 2 is an exploded view of the speaker of the invention.

FIG. 3 is a top view of the speaker of the invention.

FIG. 4 is a cross-sectional view taken along line A-A in FIG. 3.

FIG. 5 is a cross-sectional view taken along line B-B in FIG. 3.

FIG. 6 is a structural view of the tweeter voice coil assembly of the invention.

FIG. 7 is an assembly structural view of the flexible printed circuit of the tweeter unit of the invention.

### DETAILED DESCRIPTION OF THE EMBODIMENTS

To further explain the embodiments, the present application provides drawings. These drawings form part of the disclosure of the present application and are mainly used to explain the embodiments and can be used to explain the operating principles of the embodiments in conjunction with the related descriptions in the specification. With reference to these contents, those skilled in the art should be able to understand other possible implementations and advantages of the present application. The components in the drawings are not drawn to scale, and similar component symbols are generally used to indicate similar components.

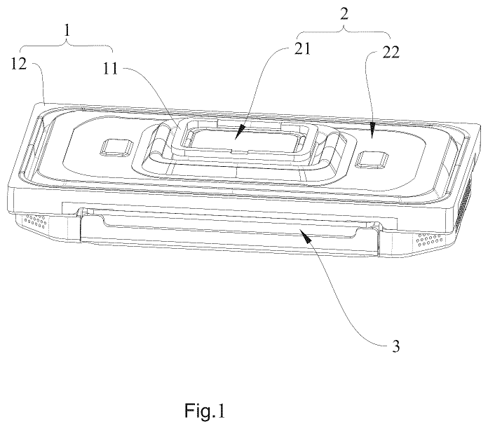

As shown in FIGS. 1 to 6, a speaker includes a frame 1 and a vibration system 2 and a magnetic circuit system 3 that are fixed to the frame 1 respectively, wherein the magnetic circuit system 3 drives the vibration system 2 to produce sound; the vibration system 2 includes a tweeter unit 21 disposed on one side of the magnetic circuit system 3, the tweeter unit 21 includes a tweeter diaphragm 211 and a tweeter voice coil assembly 212 disposed on a side of the tweeter diaphragm 211 close to the magnetic circuit system 3; the tweeter voice coil assembly 212 includes a tweeter frame 2121 and a first tweeter voice coil 2122 and a second tweeter voice coil 2123 wound around an upper portion and a lower portion of the tweeter frame 2121 respectively, wherein the first tweeter voice coil 2122 and the second tweeter voice coil 2123 are wound in opposite directions.

The speaker of the invention includes a tweeter unit 21 provided with the tweeter voice coil assembly 212, wherein the tweeter voice coil assembly 212 adopts the first tweeter voice coil 2122 and the second tweeter voice coil 2123 disposed on the upper and lower portions of the tweeter frame 2121, through optimized design of the magnetic circuit, the two voice coils can simultaneously drive the tweeter diaphragm 211, providing greater driving force for the vibration of the tweeter diaphragm 211, enhancing electromagnetic driving force, and thereby improving the high-frequency performance of the speaker; making full use of limited space while ensuring miniaturization of the speaker while maintaining high performance. It should be noted that the upper portion and the lower portion refer to two portions relatively disposed along the vibration direction of the vibration system 2.

As shown in FIG. 6, the tweeter frame 2121 includes a tubular body 21211 extending along a vibration direction of the vibration system 2 and a flange 21212 disposed at an end of the tubular body 21211 away from the magnetic circuit system 3, the flange 21212 is connected to the tweeter diaphragm 211; the first tweeter voice coil 2122 is connected to the flange 21212 and the tubular body 21211 respectively, the second tweeter voice coil 2123 is disposed at an end of the tubular body 21211 away from the first tweeter voice coil 2122.

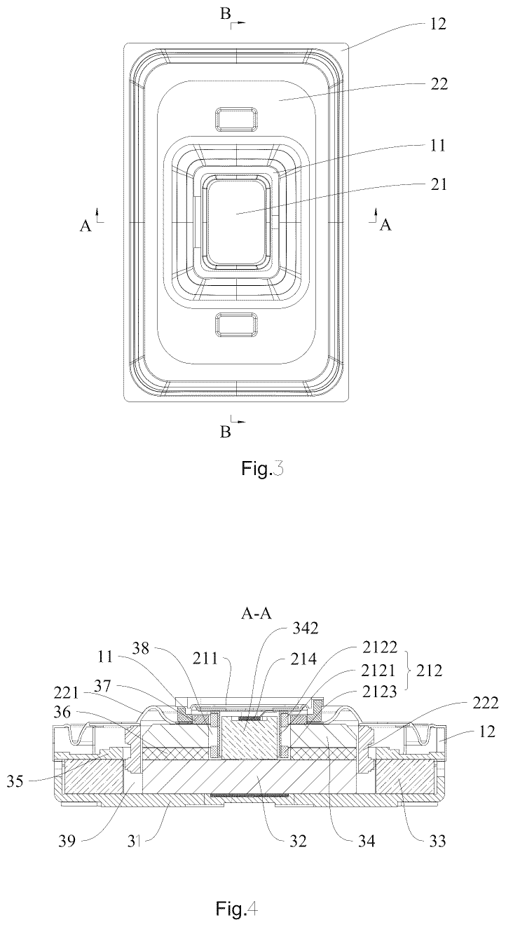

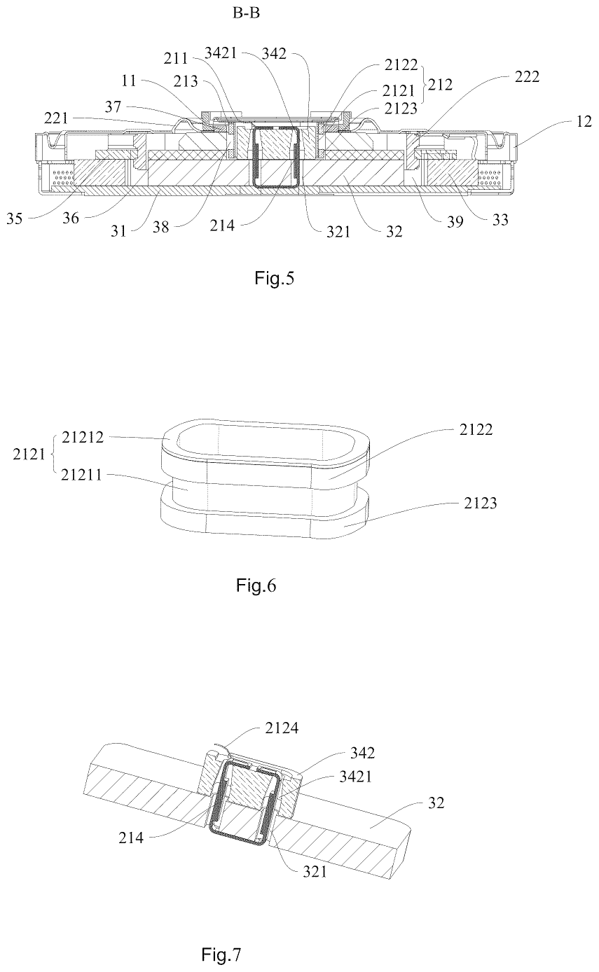

Further, as shown in FIGS. 4 and 5, in some embodiments, a reinforcement plate 213 is further disposed between the flange 21212 and the tweeter diaphragm 211 to enhance the connection strength between the flange 21212 and the tweeter diaphragm 211, ensuring the overall stability of the speaker; the reinforcement plate 213 is provided with an avoidance portion 2131 for avoiding leads 2124 of the tweeter voice coil assembly 212.

Optionally, the tweeter frame 2121 is a polyimide tweeter frame or an aluminum alloy tweeter frame. The tweeter frame 2121 adopts a lightweight and high-strength polyimide tweeter frame or aluminum alloy tweeter frame, ensuring stable support for the first tweeter voice coil and the second tweeter voice coil while avoiding the impact of the tweeter frame's own weight on the speaker's performance.

In some embodiments, the first tweeter voice coil 2122 and the second tweeter voice coil 2123 are directly series-wound on the tweeter frame 2121, that is, the first tweeter voice coil 2122 and the second tweeter voice coil 2123 are directly wound on the tweeter frame 2121. When the tweeter voice coil assembly 212 adopts this structure, it ensures that the first tweeter voice coil 2122 and the second tweeter voice coil 2123 can be directly connected in series through winding.

In other embodiments, the first tweeter voice coil 2122 and the second tweeter voice coil 2123 are wound separately and then bonded or welded to the tweeter frame 2121, that is, the first tweeter voice coil 2122 and the second tweeter voice coil 2123 are formed by winding and then assembled onto the tweeter frame 2121, followed by bonding or welding connection between the first tweeter voice coil 2122 and the second tweeter voice coil 2123 and the tweeter frame 2121. This structure arrangement allows the first tweeter voice coil 2122 and the second tweeter voice coil 2123 to be formed separately from the tweeter frame 2121 and then assembled together during the manufacturing process, improving production efficiency.

As shown in FIGS. 1 to 5, the magnetic circuit system 3 includes a first magnetic yoke 31, a center magnet 32 and a first side magnet 33 received on the first magnetic yoke 31, and a second side magnet 34 disposed on a side of the center magnet 32 close to the vibration system 2, the first side magnet 33 is spaced apart from an outer periphery of the center magnet 32, the first side magnet 33 and the second side magnet 34 are both magnetized in opposite directions with respect to the center magnet 32; a second magnetic yoke 35 is disposed on a surface of the first side magnet 33 away from the first magnetic yoke 31, a third magnetic yoke 36 is disposed between the center magnet 32 and the second side magnet 34, a fourth magnetic yoke 37 is disposed on a side of the second side magnet 34 away from the third magnetic yoke 36, a side wall of the second magnetic yoke 35 is aligned with a side wall of the first side magnet 33, a side wall of the third magnetic yoke 36 is aligned with a side wall of the second side magnet 34; the frame 1 includes a first frame 11, the tweeter diaphragm 211 is supported on the first frame 11, the first frame 11 is disposed on the second side magnet 34, the fourth magnetic yoke 37 is disposed on an inner side of the first frame 11.

A hole structure 341 is formed in a central region of the second side magnet 34, a tweeter inner pole piece 342 is disposed in the hole structure 341 and spaced apart from an inner wall of the hole structure 341, an inner wall of the fourth magnetic yoke 37 is aligned with an inner wall of the second side magnet 34, the tweeter inner pole piece 342 is disposed on the center magnet 32, a first magnetic gap 38 is formed between the tweeter inner pole piece 342 and the inner wall of the second side magnet 34, the tweeter voice coil assembly 212 is inserted into the first magnetic gap 38.

The tweeter inner pole piece 342 is a tweeter inner pole plate or a tweeter inner magnet. When the tweeter inner pole piece 342 is a tweeter inner pole plate, the tweeter inner pole plate is made of magnetic material through sintering or stamping.

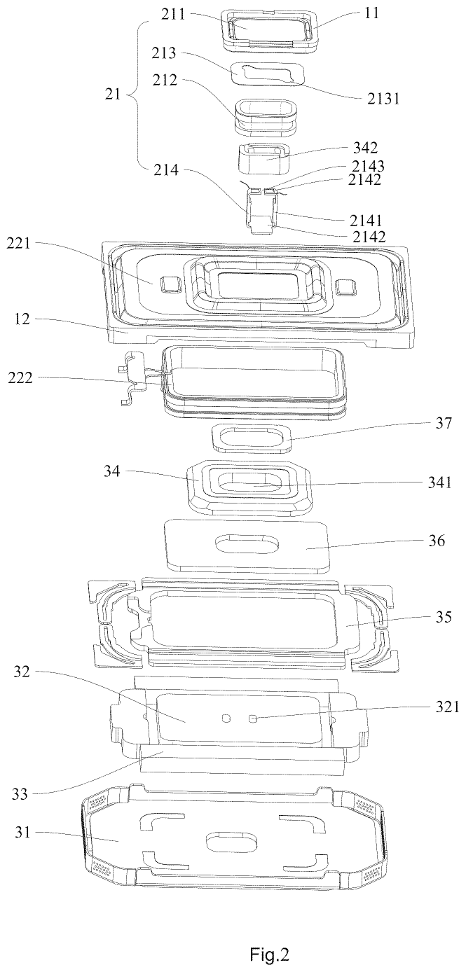

As shown in FIGS. 2 to 7, the tweeter unit 21 further includes a flexible printed circuit (FPC) 214, the FPC 214 is formed as an open ring as a whole, the FPC 214 includes a first portion 2141 and a second portion 2142 connected between the first portion 2141, the first portion 2141 passes through the tweeter inner pole piece 342 and the center magnet 32 respectively, the second portion 2142 is connected to a top surface of the tweeter inner pole piece 342 and a bottom surface of the center magnet 32 respectively; a first through hole 3421 and a second through hole 321 for the FPC 214 to pass through are formed in the tweeter inner pole piece 342 and the center magnet 32 respectively. It should be noted that the top surface refers to the plane close to the first tweeter voice coil 2122, and the bottom surface refers to the plane close to the second tweeter voice coil 2123.

The vibration system 2 further includes a woofer unit 22 coaxially disposed with the tweeter unit 21, the woofer unit 22 is disposed surrounding an outer periphery of the tweeter unit 21; the frame 1 further includes a second frame 12, the woofer unit 22 includes a woofer diaphragm 221 fixed to the second frame 12 and a woofer voice coil 222 driving the woofer diaphragm 221, the woofer voice coil 222 is disposed on a side of the woofer diaphragm 221 close to the magnetic circuit system 3, the second frame 12 is disposed on the second magnetic yoke 35. The second frame 12 is disposed surrounding an outer periphery of the first frame 11 and coaxially with the first frame 11.

A second magnetic gap 39 is formed between the first side magnet 33 and the center magnet 32, the woofer voice coil 222 is inserted into the second magnetic gap 39.

The foregoing is merely illustrative of embodiments of the present invention, and it should be noted that modifications may be made to those skilled in the art without departing from the spirit of the invention but are intended to be within the scope of the inventio.

What is claimed is:

1. A speaker, comprising:
a frame;
a vibration system fixed to the frame;
a magnetic circuit system fixed to the frame driving the vibration system to produce sound; wherein
the vibration system includes a tweeter unit disposed on one side of the magnetic circuit system, the tweeter unit includes a tweeter diaphragm and a tweeter voice coil assembly disposed on a side of the tweeter diaphragm close to the magnetic circuit system;
the tweeter voice coil assembly includes a tweeter frame and a first tweeter voice coil and a second tweeter voice coil wound around an upper portion and a lower portion of the tweeter frame respectively; and
the first tweeter voice coil and the second tweeter voice coil are wound in opposite directions.

2. The speaker as described in claim 1, wherein the tweeter frame includes a tubular body extending along a vibration direction of the vibration system and a flange disposed at an end of the tubular body away from the magnetic circuit system, the flange is connected to the tweeter diaphragm; the first tweeter voice coil is connected to the flange and the tubular body respectively, the second tweeter voice coil is disposed at an end of the tubular body away from the first tweeter voice coil.

3. The speaker as described in claim 2, wherein a reinforcement plate is disposed between the flange and the tweeter diaphragm, the reinforcement plate is provided with an avoidance portion for avoiding leads of the tweeter voice coil assembly.

4. The speaker as described in claim 1, wherein the tweeter frame is a polyimide tweeter frame or an aluminum alloy tweeter frame.

5. The speaker as described in claim 1, wherein the first tweeter voice coil and the second tweeter voice coil are directly series-wound on the tweeter frame.

6. The speaker as described in claim 1, wherein the first tweeter voice coil and the second tweeter voice coil are wound separately and then bonded or welded to the tweeter frame.

7. The speaker as described in claim 1, wherein the magnetic circuit system includes a first magnetic yoke, a center magnet and a first side magnet received on the first magnetic yoke, and a second side magnet disposed on a side of the center magnet close to the vibration system, the first side magnet is spaced apart from an outer periphery of the center magnet; the first side magnet and the second side magnet are both magnetized in opposite directions with respect to the center magnet; the frame includes a first frame, the tweeter diaphragm is supported on the first frame, the first frame is disposed on the second side magnet.

8. The speaker as described in claim 7, wherein a hole structure is formed in a central region of the second side magnet, a tweeter inner pole piece is disposed in the hole structure and spaced apart from an inner wall of the hole structure, the tweeter inner pole piece is disposed on the center magnet, a first magnetic gap is formed between the tweeter inner pole piece and the inner wall of the second side magnet, the tweeter voice coil assembly is inserted into the first magnetic gap.

9. The speaker as described in claim 8, wherein the tweeter inner pole piece is a tweeter inner pole plate or a tweeter inner magnet.

10. The speaker as described in claim 8, wherein the tweeter unit further includes a flexible printed circuit (FPC), the FPC is formed as an open ring as a whole, the FPC includes a first portion and a second portion connected between the first portion, the first portion passes through the tweeter inner pole piece and the center magnet respectively, the second portion is connected to a top surface of the tweeter inner pole piece and a bottom surface of the center magnet respectively; a first through hole and a second through hole for the first portion to pass through are formed in the tweeter inner pole piece and the center magnet respectively, an opening of the FPC is disposed on the second portion connected to the top surface of the tweeter inner pole piece.

11. The speaker as described in claim 7, wherein the vibration system further includes a woofer unit coaxially disposed with the tweeter unit, the woofer unit is disposed surrounding an outer periphery of the tweeter unit; the frame includes a second frame, the woofer unit includes a woofer diaphragm fixed to the second frame and a woofer voice coil driving the woofer diaphragm.

12. The speaker as described in claim 11, wherein a second magnetic gap is formed between the first side magnet and the center magnet, the woofer voice coil is inserted into the second magnetic gap.
